(19) United States
(12) Patent Application Publication
(10) Pub. No.: US 2011/0153160 A1
(43) Pub. Date: Jun. 23, 2011

(54) STEERING WHEEL ASSEMBLY FOR A MOTOR VEHICLE

(75) Inventors: Rogier Hesseling, Berlin (DE); Delf Neumann, Berlin (DE); Koshan Mahdi, Berlin (DE)

(73) Assignee: Takata-Petri AG, Aschaffenburg (DE)

(21) Appl. No.: 12/676,789

(22) PCT Filed: Sep. 8, 2008
(86) PCT No.: PCT/EP08/07335

§ 371 Date: Mar. 5, 2010

Related U.S. Application Data
(60) Provisional application No. 61/060,344, filed on Jun. 10, 2008.

(30) Foreign Application Priority Data
Sep. 6, 2007 (DE) 10 2007 043 005.3
Sep. 6, 2007 (DE) 10 2007 043 008.8

(51) Int. Cl. G06F 7/00; B62D 6/00

(52) U.S. Cl. 701/41; 701/1

(57) ABSTRACT

A steering wheel assembly for a motor vehicle is provided. The steering wheel assembly having a steering wheel for steering the motor vehicle, at least one vehicle component that is to be arranged at the steering wheel, and an electronic control unit for processing information and for controlling the at least one vehicle component. The electronic control unit is arranged in the steering wheel.

The invention relates to a steering wheel assembly for a motor vehicle having a steering wheel for steering the motor vehicle, at least one vehicle component that is to be arranged at the steering wheel, and a control unit for controlling the at least one vehicle component.

The present invention is based on the object of making available a steering wheel assembly for a motor vehicle of the afore-mentioned kind that is more versatile and offers increased safety.

This object is achieved according to the invention by means of a steering wheel assembly having the features of Claim 1. According thereto, the control unit which is also referred to as control device or ECU (electronic control unit) is an integral part of the steering wheel. Refinements of the invention are disclosed in the sub claims.

Due to processing of information (driver and vehicle related information) and computation of such data by means being an integral part of the steering wheel, i.e., being located inside the steering wheel, an additional communication path between the steering wheel and the motor vehicle is abdicable.

As a consequence, one has a lower load of the vehicle bus, no additional cables of the contact unit, and increased safety due to direct and thus faster transformation of information into action.

In this respect, said contact unit is a part, which is designed for signal transformation and power supply of components arranged in the steering wheel. The contact unit is arranged at a side of the hub facing the steering shaft. Said unit comprises a rotor that is attached to the steering wheel, so that it cannot rotate with respect to the steering wheel, and a stator which is attached to the steering shaft. Rotor and stator are electrically connected by a buffer spring (or clockspring). The buffer spring is designed for assuring a proper electrical connection between the fixed cable harness at the steering shaft and the movable steering wheel and the components arranged therein. The buffer spring is a spirally wound conducting band (comprising a plurality of layers), which is thus able to follow the rotation of the steering wheel, without breaking apart.

A further advantage lies within the fact, that—under certain premises—the steering wheel can be exchanged, since possible adaptation procedures can be handled on a software level and preferably do not involve changes in hardware. This is beneficial when it comes to using different steering wheel equipment versions with the same motor vehicle type.

Preferably, said at least one vehicle component is an integral part of a steering wheel rim that is adapted and provided for actuating the steering wheel, i.e., for manually adjusting a steering angle of the steering wheel. In an alternative refinement, the at least one vehicle component is arranged at a hub body via which the steering wheel is connected to a control rod of a steering gear (steering shaft). The steering angle is measured in a plane perpendicular to the steering shaft with respect to a reference position of the steering wheel, say, when the vehicle drives straight ahead, and thus increases when the steering wheel is rotated out of this position, for instance towards the right hand side of the driver. Other definitions may also be appropriate.

Preferably, the at least one vehicle component is designed as an actuator of a superposition steering system wherein the control unit is preferentially designed for determining an optimal and necessary steering angle depending from the actual dynamics of vehicle movement, and wherein the control unit is preferably further designed to compare said steering angle with the current steering angle adjusted by the driver (person) via the steering wheel (and as the case may be to compare said steering angle with the current driving characteristic set by the steering system), and wherein the control unit is further designed to determine a corrective steering angle and to adjust said corrective steering angle by means of an actuator in a way that an optimized steering angle is translated to the steered wheels by means of the steering shaft.

In such a steering system, the steering wheel is preferably decoupled from the steered wheels or can be decoupled from said wheels.

Particularly, said actuator can be activated as a function of information of at least one vehicle sensor in such a way that it (the actuator) applies a force to the steering wheel and/or a steering shaft and/or makes available information to the driver.

Preferably, the actuator comprises a motor and a gear connected to said motor, wherein the control unit is preferably connected to the motor for controlling said motor, particularly via a motor driver that is designed for converting control signals for controlling the motor into electrical signals that can actually be handled by the motor. For instance, the motor driver can generate such electrical signals by means of a suitable software.

In a refinement, the control device performs open-loop or closed-loop control (i.e. with feedback) of the actuator and receives signals from at least one vehicle sensor.

In another refinement a superposition steering system for a motor vehicle is provided, that is designed for correcting a steering angel that is manually adjusted by the driver by means of the steering wheel and/or to provide synthetic feedback to the driver as explained below, wherein the steering wheel assembly is particularly designed for being decoupled or for becoming decoupled from the steered wheels of the motor vehicle.

In yet another refinement, the at least one vehicle component is designed as a display device. Of course, it is also possible to provide the afore-described actuator in combination with such a display device.

Preferably, the display device comprises a display, which can be designed as a LCD, a TFT or a OLED. Other types of displays may also be employed. In particular, such a display is controlled by the control unit (ECU) which is connected to the display accordingly, preferably via a display driver that is designed to convert control signals for controlling the display into electrical signals that can be handled by the display.

In addition, the display device preferably comprises a plurality of LEDs for depicting vehicle information. In this context, in order to produce homogeneously illuminated, elongated stripes symbolizing vehicle information on a surface of the display device (which can be seen by the driver) in order to inform, instruct or warn the driver, a reflector means is provided that is adapted and provided for cooperating with the LEDs in order to generate said illuminated stripes.

Preferentially, the control unit is further connected to the LEDs in order to control the LEDs, particularly by means of a LED driver that is designed for transforming control signals for controlling the LEDs into electrical signals that can actually be handled by the LEDs, i.e., illuminate the LEDs in an intended manner. Particularly, the control unit is designed for controlling further vehicle components. Such a component can be a heating element, a means for sensing a steering angle (sensor), a lighting means, or an actuating element for activating a vehicle component. Said further vehicle components are preferably arranged in the steering wheel, particularly in one of the following locations: in the steering wheel rim, in the a hub body, and in a spoke connecting the hub body to the steering wheel rim. In this respect, components that are relatively large in size, for instance said actuator and a driver of the superposition steering system, are preferably arranged in the hub body of the steering wheel, since these components may produce a reasonable amount of heat during operation and therefore require larger cooling surfaces.

In a refinement, the control unit is adapted and provided for being coupled to a bus on the motor vehicle side via a bus transceiver, i.e., a device that can send and receive signals via said bus. Particularly, the control unit is connected to a memory means that is to be arranged in the motor vehicle, particularly, said memory means serves for storing image information that is to be displayed by the display device and/or for storing information that is needed for the generation of control signals for said superposition steering system. In a refinement of the invention, said memory means is an integral part of the control unit, while in another refinement of the invention, said memory means is designed separately with respect to the control unit. In this case, the memory means is preferably adapted and provided for being connected to the control unit via a bus on the motor vehicle side in order to transmit image information or other data stored in said memory means to said control unit.

Preferably, the control unit is either arranged in a steering wheel rim, a hub body of the steering wheel, or in a spoke of the steering wheel, which spoke connects the steering wheel rim with the hub body.

Preferentially, the steering wheel rim comprises a base body as a skeleton of the rim, that is at least partly surrounded by a cladding of the steering wheel rim, wherein such cladding preferably consist of a foam.

For supporting parts of the control unit, at least one circuit board (printed circuit board) is provided. In a refinement of the invention, at least one further vehicle component, particularly a component that is controlled by the control unit, is arranged on the circuit board. These components can be the LEDs, the LED driver, the display, the display driver, a dc/dc converter, sensors, as well as parts of actuators of a superposition steering system.

In a refinement of the invention said circuit board is thermally coupled to the base body for providing a cooling of the circuit board and the parts thereon. Additionally, or alternatively, at least one of the further vehicle components, particularly the LEDs, the LED driver, the display, the display driver or the dc/dc may be individually coupled thermally to the base body.

In a further refinement of the invention, the control unit comprises at least two separate circuit boards, wherein particularly at least one of said circuit boards is thermally coupled to the base body.

For providing reasonable cooling, also a part of the steering wheel or a plurality of such parts to which the control unit has contact—either directly or via another part—can be designed as heat sinks. Vehicle components that are controlled by the control unit can be cooled in the same manner.

Another way of providing necessary cooling is to arrange at least one of the afore-described vehicle components in a spoke of the steering wheel for better dissipation of heat generated by said component. Preferably, vehicle components like the LEDs, the LED driver, the display, the display driver, and the dc/dc converter can be cooled this way.

In particular, the control unit described above is able to do all the signal processing that is necessary for controlling the at least one vehicle component, i.e., no further processing unit is required. Especially, the control unit is adapted to process (read) vehicle information from a bus on the motor vehicle side.

Information that is necessary for the control unit in order to control vehicle components is provided by vehicle sensors which are arranged in the steering wheel or outside the steering wheel. These sensors are for instance related to the dynamics of vehicle movement, and as such may sense the steering angle, the angular speed of the steering wheel, the angular acceleration of the steering wheel and a yaw torque (see below) or may detect the brightness in an environment of the motor vehicle or inside the motor vehicle as well as information related to the driver (see below).

Preferentially, the control unit is further designed for processing driver information that is recorded by a driver monitoring device, such as a camera, wherein said monitoring device is preferably an integral part of the steering wheel. In this context, the control unit is preferably adapted for controlling the at least one vehicle component as a function of said driver information which the control unit receives via the monitoring device. Such driver information can include a state of the driver, i.e., a classification of the concentrativeness and/or attentiveness of the driver, both of which can be measured by analyzing (by means of said monitoring device and said control unit) for instance the eye movement of the driver, the line of sight or the position of the driver's head (for instance with respect to the chest of the driver or a fixed point in the vehicle).

In a further variant of the invention, the control unit is designed for processing brightness information which is sensed by means of a brightness sensor preferably arranged in the steering wheel. In this respect, the control unit is especially designed for controlling the at least one vehicle component depending on said brightness information. By means of such a sensor, the control unit is able to adjust the brightness of the display at all times according to the actual light conditions in an environment of the motor vehicle or inside the motor vehicle.

Furthermore, the control unit is preferably designed for reading vehicle information from a bus on the motor vehicle side in an autonomous manner, particularly without preparation of the motor vehicle bus system with respect to the additional bus member in form of the steering wheel or a change in the bus architecture. In this context, the control unit is preferentially designed for treating diagnose and/or data safety monitoring information in an autonomous fashion, wherein the control unit is designed for displaying such information on the display of the display device.

The following deals with another aspect of the present invention.

In conventional steering wheels, there is a continuous mechanical connection between the steering wheel and the steered wheels, with the result that the forces acting on the steered wheels can be felt in the steering wheel. There is in this respect feedback of the vehicle/wheel travel behavior to the driver.

In order to reduce the required steering forces, what is referred to as a power steering system is known which assists the driver in steering by means of a hydraulic drive or an electric drive by boosting the force which is applied by the driver for the purpose of steering.

Conventional steering systems provide a fixed transmission ratio between the steering wheel and the wheels. What is referred to as active steering is likewise known in which the steering transmission ratio is adapted to the vehicle's velocity, with the result that, for example, at low velocities a small steering wheel lock leads to a relatively large steering angle, which leads, for example when parking, to less steering work.

The terms “ESP” (Electronic Stability Program) or “ESC” (Electronic Stability Control) refer to a technology in which, by selective automatic braking of individual wheels, oversteering or understeering of a vehicle is to be prevented. The system utilizes the signals from various sensors which are evaluated by a control device and makes available control signals to special actuators for selectively automatically braking individual wheels.

Furthermore, the term “steer-by-wire” refers to steering systems in motor vehicles in which a steering instruction is fed exclusively by electrical means via a control device to an actuator which carries out the steering instruction. In this context, signals relating to the desired direction of travel are transmitted to the control device via one or more sensors on the steering wheel or some other input device. There is no mechanical connection between the steering wheel and the wheels to be steered.

The steering wheel system that was described above in the context of a control unit located in the steering wheel is by itself an advantageous invention. Such a steering system for a motor vehicle has at least a steering wheel which is decoupled or can be decoupled from the steered wheels of the motor vehicle. Preferably, in the event of such decoupling, the system makes available increased driving comfort and/or safety comfort to the driver. It is crucial to this inventive aspect that this steering system has at least one actuator which, as a function of information of at least one vehicle sensor, applies a force to the steering wheel and/or the steering shaft and/or makes available information to the driver.

Thus, such a steering system preferably makes available “synthetic” feedback of the vehicle/wheel travel behavior to the driver using one or more actuators. This synthetic feedback makes it possible that, despite the absence of a mechanical connection between the steered wheels and the steering wheel, the vehicle/wheel travel behavior is communicated to the driver and/or can be used for a steering correction.

The actuator or actuators impress a torque relative to the steering column or to the steering wheel base.

In this context, there is provision in one refinement of such a steering system that, for synthetic feedback of the vehicle/wheel travel behavior at least one actuator applies, as a function of information from at least one vehicle sensor, a torque, which can be felt by the driver, to the steering wheel or to the steering shaft. For example, the actuator causes the steering wheel rim to vibrate or applies a torque thereto with a frequency which can be felt clearly, in order in this way to emphasize or boost forces and torques which act on the wheels or on the steering shaft. For example, cyclic vibration is generated if the car travels over cobblestones. Vibrations in the steering wheel rim can also be used to warn against imminent critical driving situations or critical driving situations which are already occurring. According to this embodiment variant, the force which is applied to the steering wheel or to the steering shaft by the actuator does not intervene in the steering process, i.e. it does not change the direction of travel of the vehicle.

It is also possible for the feedback to the driver to be made available by means of acoustic and/or visual information. For example, a warning signal is generated on a display, that can be an integral part of the steering wheel rim, or a warning tone or a voice signal is produced.

In a further refinement of such a steering system, at least one actuator performs a steering wheel correction as a function of information from at least one vehicle sensor. Said steering wheel correction is based, for example, on adjustment of the yaw rate, the yaw acceleration, the differential-action steering and/or suppression of the crosswind. In this context, in one refinement the steering correction (a change in the steering angle) is carried out in a way which cannot be felt by the driver in that a movement is superposed on the movement of the steering wheel without the driver being made aware of this. This permits a steering correction system to intervene dynamically in the steering process.

In a further refinement of such a steering system, at least one actuator replaces the variable tooth pitch of the gear rack of a rack and pinion steering system, for example within the scope of an active steering system.

In one refinement of said steering system it is possible to activate a mechanical connection between the steering wheel and the steered wheels as a fallback option, i.e. it is available as a replacement if the electrical systems fail. On a standard basis, the mechanical connection is active and is not disconnected until after the “ok message” from the system components. For example it is possible to provide that the decoupling of the steering wheel from the steered wheels of the motor vehicle is implemented by means of a switch which actively disconnects the mechanical connection between the steering wheel and the wheels.

In another refinement of the steering system in question, the steering wheel is continuously mechanically decoupled from the steered wheels of the motor vehicle. For example, there is no mechanical coupling of the steering wheel to the steered wheels of the motor vehicle, and steering instructions to the wheels are transmitted to the wheels electrically by means of one or more sensors, a control device and one or more actuators (steer-by-wire).

It is also possible to provide that the decoupling of the steering wheel from the steered wheels of the motor vehicle is implemented by means of strong attenuation of at least a number of components of the mechanical chain of connection between the wheels and the steering wheel, that is to say vibrations originating from the wheels can hardly be felt in the steering wheel.

The actuator or actuators of the steering system are preferably arranged in the steering wheel, with the result that they can apply a force or a torque directly to the steering wheel or to the steering shaft.

In one refinement of the steering system, open-loop or closed-loop control of the actuator is performed by means of an electric control device (control unit), also referred to as an ECU (Electronic Computational Unit), which receives signals from at least one vehicle sensor and processes them to form controlling instructions to one or more actuators. The electric control device may be configured here with intelligence in the sense that it makes a decision as to whether and in what way input signals from one or more vehicle sensors are converted into control signals or actuation signals to one or more actuators. It is possible to provide, for example, that when the incoming sensor signals indicate that a pothole is traveled over, this information is not converted into a control signal to an actuator in order to avoid irritating the driver. This is a comfort decision of the control device.

In one refinement of the steering system, the electronic control device is integrated into the steering wheel or into the steering column. In one refinement of the invention, at least one vehicle sensor is also arranged in the steering wheel, for example a sensor for measuring the steering angle of the steering wheel and/or a sensor for measuring the angular speed of the steering wheel and/or a sensor for measuring the angular acceleration of the steering wheel.

For example one or more acceleration sensors and/or one or more wheel sensors are used as vehicle sensors whose information is employed for use by at least one actuator which applies a force to the steering wheel and/or the steering shaft and/or makes available information to the driver. An acceleration sensor is, for example, a yaw rate sensor which detects a yaw torque. Another example of an acceleration sensor is a sensor for detecting a stretch of road in poor condition. Possible wheel sensors are wheel steering angle sensors and wheel torque sensors.

An actuator is made available, for example, by means of an electric motor with a transmission which is in engagement with the steering wheel hub or with some other part of the steering wheel.

The invention also relates to a method in a steering system of a motor vehicle having a steering wheel which is decoupled or can be decoupled from the steered wheels of the motor vehicle. The following steps are provided:
acquisition of a signal of at least one vehicle sensor,
generation of a control signal for an actuator as a function of the acquired signal, and
application of a force to the steering wheel and/or the steering shaft and/or provision of information to the driver of the motor vehicle by the actuator when a corresponding control signal is present.

In addition, information which is permanently stored in a control device can be used to generate the control signal.

The invention is explained in more detail below with regard to exemplary embodiments illustrated in the figures, in which:

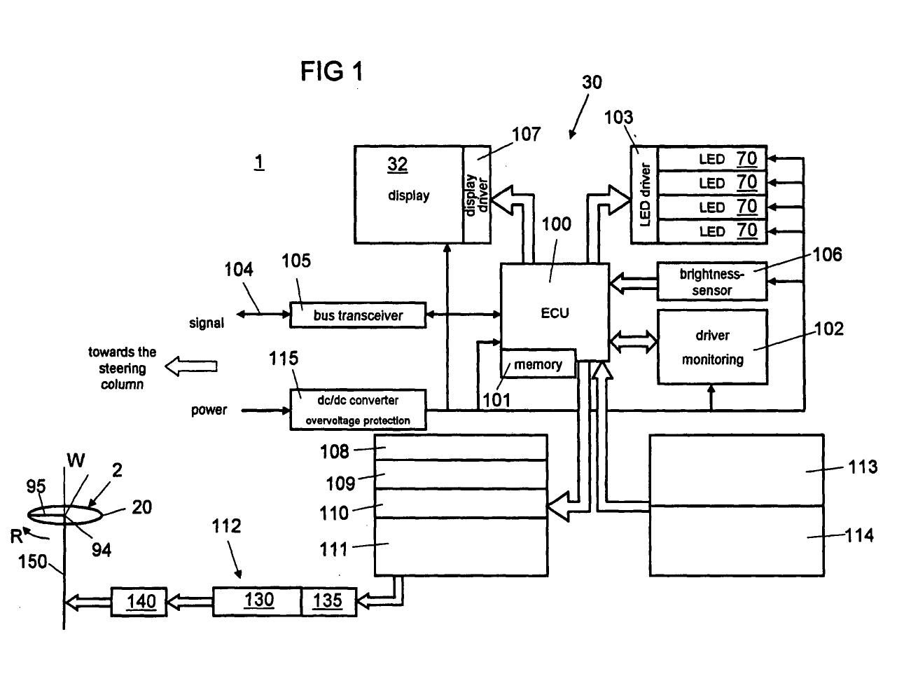

FIG. 1 shows a block diagram of a steering wheel assembly according to the invention,

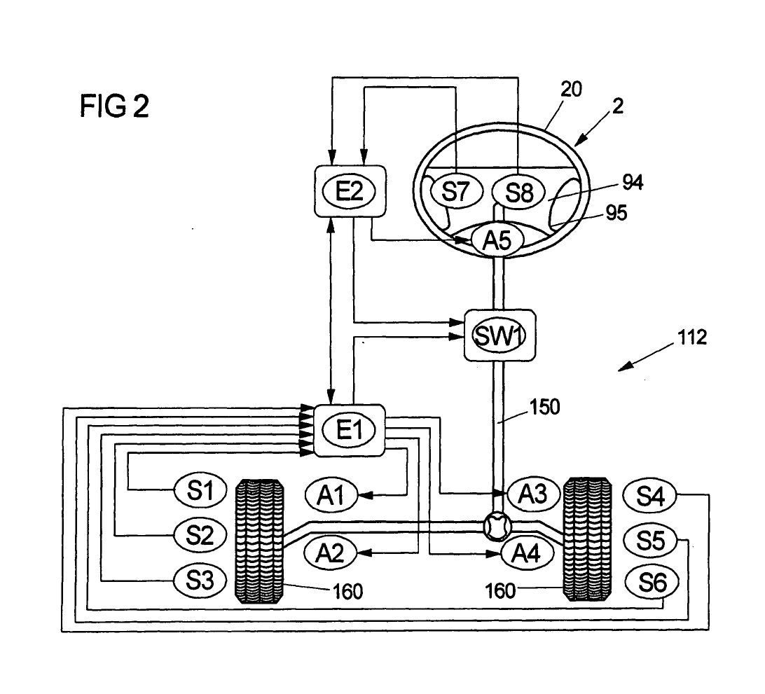

FIG. 2 shows a steering system for a motor vehicle in which sensors and actuators are assigned both to the wheels and to the steering wheel,

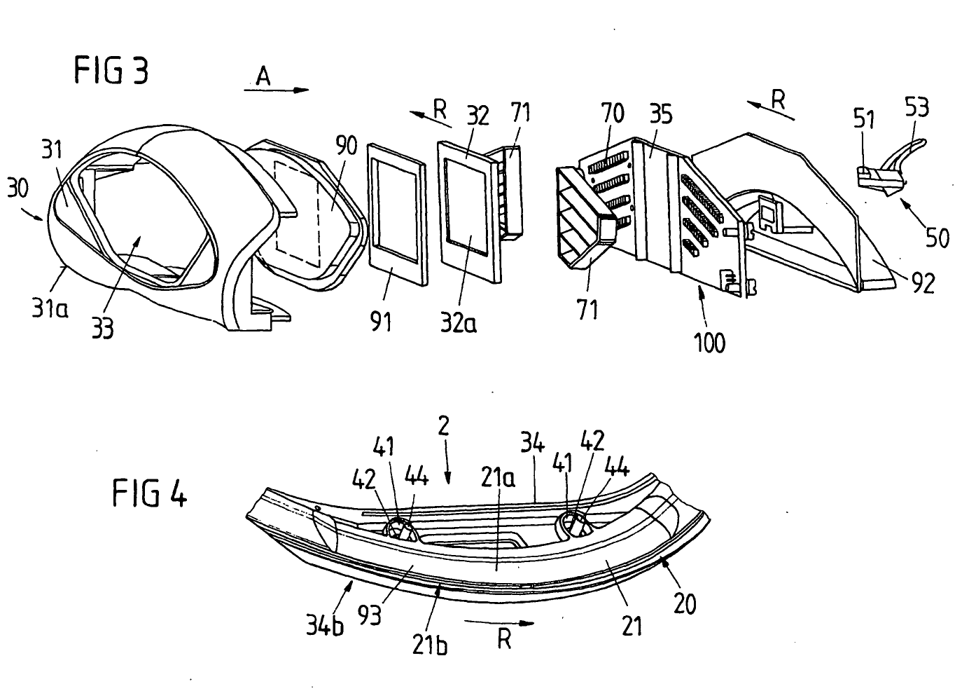

FIG. 3 shows an exploded view of a display device including a control unit for controlling a display of the display device as well as an actuator of a steering system,

FIG. 4 a detail of a perspective view of a base body of a steering wheel and a lower shell of a display device as shown in FIG. 1,

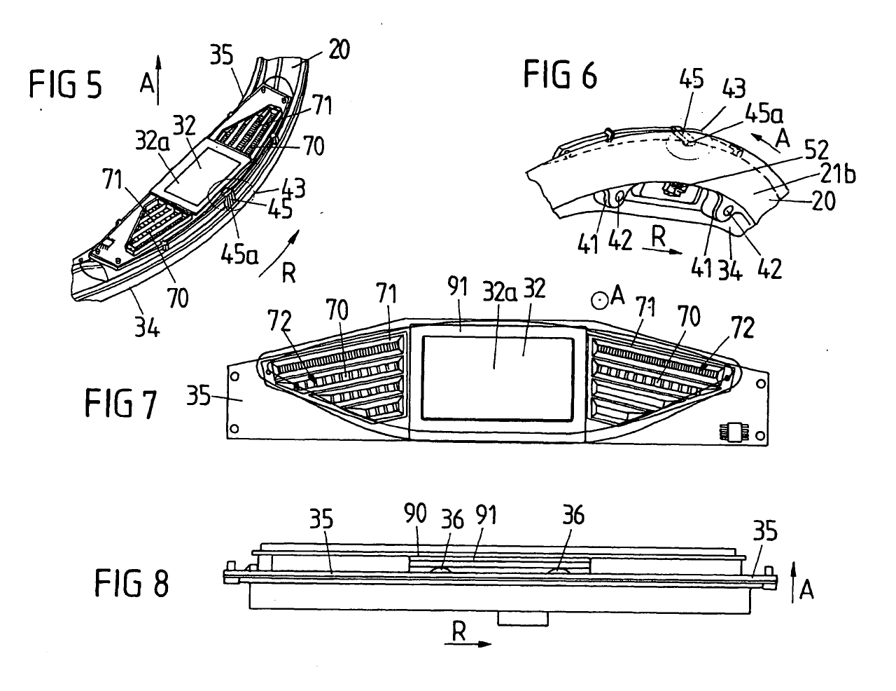

FIGS. 5-6: perspective views of a display device as shown in FIG. 1, that is connected to the base body by means of a latching means (clip connection),

FIGS. 7-8: views of a display device according to FIG. 1, with a display being connected to the base body via elastic damping means.

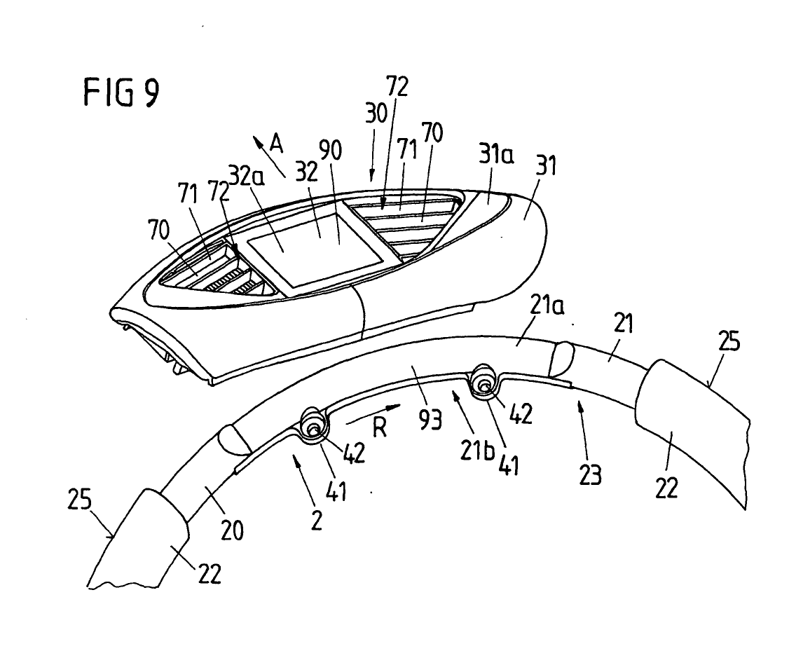

FIG. 9: an exploded view of a steering wheel rim having an exposed section of the base body, to which section the display device is attached.

FIG. 1 shows on the basis of a block diagram a control unit 100 of a steering wheel assembly 1 according to the invention as well as further components connected to the control unit 100.

The control unit 100 can be designed for controlling a vehicle component in the form of a display device 30 as well as further vehicle devices that can be arranged in the motor vehicle or a steering wheel 2 of the assembly (cf. FIGS. 2 and 9). Particularly, the control unit 100 is adapted and provided for controlling a superposition steering system 112.

Therefore, the control unit 100 is able to determine an optimal steering angle of the steering shaft 150 (or steering wheel 2) depending from the actual dynamics of vehicle movement. Thus, a vehicle sensor in form of a steering angle sensor 113 is provided, which is connected to the control unit 100 in order to send the current steering angle W to the control unit 100. In turn, the control unit 100 is adapted to compare this steering angle W with the optimal one, and to determine a corrective steering angle based on this comparison. On the basis of this corrective steering angle an actuator 111 that is controlled by the control unit 100 adjusts the current steering angle W to an optimized steering angle by acting on the steering shaft 150 correspondingly. For this purpose the actuator 111 comprises a motor 130 and a gear 140 coupled to said motor 130, wherein the control unit 100 is connected to the motor 130 for controlling said motor 130, particularly via a motor driver 135, that is designed for transforming control signals for the motor 130 into electrical signals that can be processed by the motor 130. This motor 130 imposes a force (torque) onto the steering shaft 150 via the gear 140 when activated by the control unit 100 via the motor driver 135 in the steering process described above in order to correct the current steering angle W as adjusted by the driver manually via the steering wheel (2).

In addition, the control 100 unit can be designed for receiving signals from a steering angle acceleration sensor 114 that is capable of detecting the rate of a change in the steering angle W. Then, the control unit 100 may be adapted to use also the current rate of change in the steering angle W caused by the driver to determine the optimal steering angle, and/or, as the case may be, the optimal rate of change in the steering angle, in order to correct the steering angle W and/or said rate—as set by the driver—properly. The above-described process is known as superposition steering.

Such an actuator 111 is preferably arranged in a steering wheel hub 94 (although not shown in FIG. 1) by means of which the steering wheel 2 is rotatably supported in the motor vehicle, as for instance shown in FIG. 2. The hub body 94 is connected to the rim 20 via at least one spoke 95 of the steering wheel 2.

Furthermore, the control unit 100 can be adapted to control a display 32 as well as LEDs 70 that reside in reflector means 71. By means of these reflector means 71 elongated stripes on a surface of the steering wheel rim 20 can be homogeneously illuminated in order to inform the driver in a concise manner. Images that are to be displayed by the display 30 (or the LEDs 70) are deposited in a separate memory means 101 that can be an integral part of the control unit 100, but can also be designed separately with respect to the control unit 100, or are transmitted via a vehicle bus 104 or vehicle sensors to the control unit 100. An additional driver monitoring device 102 (for instance in form of a camera) is also controlled by means of the control unit 100.

Further vehicle components that are arranged in the steering wheel 2, like for instance a steering wheel heating 108, a lighting 109, actuating means 110 and so on, can be controlled by the control unit 100 as well.

A circuit board 35 (cf. FIGS. 3, 5 and 7) that supports the display 32 and the control unit 100 can be split off in two ore more separate circuit boards in order to achieve a desired distribution of parts or to separate those parts that generate a reasonable amount of heat during operation. In this way, heat generating parts (LED driver 103, LEDs 70 etc.) can be connected to the base body 21 of the steering wheel 2 via heat dissipation tapes to achieve a better dissipation of heat. Hereby heat can be kept away from those parts that are heat-sensitive, like for instance a display 32 in form of an OLED.

Other heat generating parts can be organized on separate circuit boards in the area of the spokes 95 of the steering wheel 2 (for instance due to a lack of installation space or due to the heat generating properties of the respective parts).

Generally, the control unit 100 is configured such that the steering wheel 2 in conjunction with the afore-described sensors, the control unit 100 and any other actuators, like for instance actuator 111, constitutes an autonomous unit. Thereby any processing of signals is carried out invisibly inside the steering wheel 2. In particular, the control unit 100 is arranged in the steering wheel 2, namely in the steering wheel rim 20. In case a display device 30 is present, the control unit 100 is preferably housed in a housing 31, 34 of said display device 30.

Due to its property as an autonomous device, the complete steering wheel 2 can be mounted into each vehicle, wherein the integration into the respective vehicle is uncomplicated and, in particular, does not involve an adaptation of the vehicle architecture. Additional vehicle information can be simply read from an existing vehicle bus 104. Hereby diagnose and other data safety monitoring mechanism can be directly handled by the steering wheel 2. Particularly, specialized steering wheels 2 can be offered as optional equipment for certain vehicle types.

In detail, the control 100 unit is connected to the at least one vehicle component 30, 111 and the other (optional) vehicle components and sensors as shown in FIG. 1.

Most important, the control unit 100 is adapted and provided for controlling the actuator 111, the display 32, as well as the LEDs 70. For this purpose, the control unit 100 comprises a memory means 101 for depositing (storing) of vehicle and driver related information (data), and is able to exchange signals with a bus 104 on the vehicle side via a bus transceiver 105.

In the following, the term connection denotes connections between electronic parts by means of which control signals can be transmitted or exchanged. Preferably said signal bus 104 extends along the steering shaft to the bus on the vehicle side.

Further, the control unit 100 is connected to a brightness sensor 106, so that the control unit 100 is able to control further vehicle components connected to the control unit 100 as a function of the brightness inside the vehicle or in an environment of the vehicle. Particularly, such a component can be the display 32 as well as the LEDs 70 residing in the reflector means 71, whose brightness, and as the case may be color, and contrast can be controlled depending on the brightness inside the vehicle. Therefore, the display 32 is connected to the control unit 100 via a display driver 107, and the LEDs 70 are connected to the control unit 100 via a LED-driver 103. Both drivers 103, 107 are designed for transforming the control signals of the control unit 100 into electrical signals that can be processed by the display 32 and the LEDs 70, respectively.

Additionally, the control unit 100 is connected to a driver monitoring device 102, for instance in form of a camera. In this respect, the control unit 100 is adapted and provided to detect a state of attentiveness of the driver with help of a suitable analyzing software, and to control further vehicle components as a function of the detected state of attentiveness. For instance, an optical warning can be shown to the driver by the display 32 in case the control unit 100 detects, with help of the driver monitoring device 102, that the. driver is tired or does not pay the required attention to the surrounding traffic.

The afore-described parts are preferably arranged on said circuit board 35 which is arranged in the steering wheel rim 20 and can be split off into a plurality of circuit boards.

In addition, besides the actuator 111 for the superposition steering system 112 and the display 32 and LEDs 70, the control unit 100 is designed for controlling further vehicle components that can be arranged in the steering wheel 2, like for instance the steering wheel heating 108, the lighting 109, and actuation means 110 for activating vehicle components. Thus there are also connections provided between these components and the control unit 100. These components are preferably not arranged on the circuit board 35 of the control unit 100.

Finally, the control unit is 100 connected to the afore-described steering angle sensor 113 and steering angle acceleration sensor 114. The data received from these sensors is needed to control said actuator 111 of the superposition steering system 112. Said sensors 113, 114 can also be arranged in the steering wheel 2.

For providing power supply, the control unit 100, the display 32, the LEDs 70, the brightness sensor 106, the driver monitoring device 102 are connected via a dc/dc converter 115 to an energy source on the vehicle side.

FIG. 2 shows a steering system for a motor vehicle in which sensors and actuators are assigned both to the wheels and to the steering wheel 2. In particular, one of the wheels has wheel sensors S1, S2, S3 and the other wheel has wheel sensors S4, S5 S6. Furthermore, both wheels are assigned wheel actuators A1, A2 and A3, A4.

The wheel sensors S1-S6 are, for example, a wheel steering angle sensor, a wheel torque sensor and an ABS rotational speed sensor which are respectively provided for each wheel. The wheel actuators are, for example, electric motors which superimpose a torque on an already existing mechanical torque or which actually make available a torque in the first place. For example, the wheel actuators A1, A3 are actuators for superimposing a torque, for example in a power steering system. The actuators A2, A4 are, for example, actuators for carrying out a steering instruction, such as are used in a “steer-by-wire” system.

It is to be noted that the wheel sensors and wheel actuators which are illustrated and described are to be understood as only exemplary. It is also possible to provide that a smaller number of wheel actuators and wheel sensors than illustrated is provided, for example a wheel actuator for superimposing torque or a wheel actuator for carrying out electrical steering instructions of a “steer-by-wire” system.

The wheel sensors supply, the signals/information made available by them to a first electric control device E1, which is also referred to as an ECU (Electronic Computational Unit) or simply control unit.

Furthermore, in the illustrated exemplary embodiment two steering wheel sensors S7, S8 and a steering wheel actuator A5 are provided in the steering wheel, in which case the illustrated number of steering wheel sensors and steering wheel actuators is in turn to be understood as only exemplary. The steering wheel sensors S7, S8 are, for example, a steering angle sensor for a steering wheel, an angular speed sensor for a steering wheel and/or an angular acceleration sensor for a steering wheel. A yaw rate sensor may also be provided in the steering wheel in a complementary or additional fashion. Sensors for measuring the angle of the steering shaft, the angular speed of the steering shaft and/or angular acceleration of the steering shaft may also be provided in the steering column in an additional or complementary fashion.

The actuator A5 is, for example, an electric motor which is provided for providing torque feedback to the driver and/or superimposing an angle on the steering shaft. For example, the motor generates vibration on the steering wheel rim in order to provide the driver with feedback about forces and torques acting on the wheels or on the steering shaft. The motor can also superimpose a specific angle in the steering wheel on the existing steering angle, for example within the scope of an automatic steering wheel correction. In this context it is also possible to provide a plurality of motors for implementing corresponding functions.

The signals which are output by the steering wheel sensors S7, S8 are fed to a second electric control device E2 which is responsible for controlling the actuator A5 in the steering wheel and which transmits corresponding control signals to the steering wheel actuator A5 or a plurality of such steering wheel actuators. The second control device E2 is in communication with the first control device E1 here. In particular, the signals of the steering wheel sensors S7, S8 can also be passed on to the first control device E1 which generates control signals for the wheel actuators A1-A4. For example, the first control device E1 can evaluate signals of a steering angle sensor S7 for the steering wheel and convert them into steering instructions to a wheel actuator A1-A4. Likewise, the second control device E2 can evaluate signals of the wheel sensors S1, S2, S3, S4, S5, S6. Furthermore, in one refinement at least the second control device A2 can additionally evaluate the signals of further vehicle sensors which are possibly present, for example the signals of an acceleration sensor.

In the illustrated exemplary embodiment, a switch SW1 for activating a fallback option is also provided, which switch SW1 can be actuated by both control devices E1, E2. Depending on the design, the switch SW1 is deactivated or activated if the vehicle can no longer be steered using the electronic means when the electronic system fails. It is then possible to resort to a conventional steering system so that the system has a mechanical fallback option from the steering wheel to the wheels.

In other exemplary embodiments, such a mechanical fallback option is dispensed with so that only an electronic steering system (steer-by-wire) is present.

FIG. 3 shows in conjunction with FIG. 4 the design of a display device 31 of a steering wheel assembly 1 according to the invention. According thereto, the display device comprises a cover 31—also denoted as upper first shell 31. Said shell 31 can particularly consist of PC, ABS, wood, metal etc., and comprises—with respect to a state in which the display device 30 is mounted into a steering wheel 2 as intended—a surface 31a directed towards the driver that forms a design area. The upper first shell 31 further comprises a continuous recess 33 (cut out 33), through which the display 32, that serves for displaying information, is visible. Particularly, the display 32 can be an OLED, a TFT, a LCD or any other suitable display.

With respect to said built-in state which is assumed in the following a lucent pane cover 90 is arranged between the upper first shell 31 and said display 32 along a direction of assembly A that is oriented normally to an extension plane of the upper first shell 31. The pane cover 90 covers said recess 33 and is preferably scratch-resistant, bloomed, as well as coated against fogging. Preferably, said pane cover 90 extending along the upper first shell 31 consists of PC, ABS, PMMA or PU.

The pane cover 90 and the upper first shell 31 can also constitute a uniform part, i.e., the pane cover 90 can be formed integrally with the upper first shell 31.

Furthermore, a frame shaped seal 91 is arranged between the pane cover 90 and the display 32 along the direction of assembly A. Thereby, the seal 91 circulates a display side 32a facing the driver, via which side 32a information (optical signals) can be displayed by the display 32, so as to protect the display 32 and the display side 32a from dust and humidity. In this connection, the pane cover 90 rests against the display 32 via this seal 91, wherein the pane cover 90 is pretensioned against the seal 91, so that the seal 91 rests against the display 32 as well as the pane cover 90 in a caulking manner.

The area enclosed by the frame shaped seal 91 corresponds—with respect to its projection onto the pane cover 90—to an area of the pane cover 90 having a high transparency or low diffusion (field of vision of the display 32). The border areas adjoining thereto have a low transparency or have a relatively strong dispersive effect.

The display 32 extends along an extension direction R of the steering wheel rim 20 and is arranged in the steering wheel rim 20 in the twelve o'clock position, with respect to a straight ahead driving position of the steering wheel 2.

Along the extension direction R a reflector means 71 is arranged on each side of the display, wherein said reflector means 71 is adapted and provided for interacting with light generated by the LEDs 70 in a way that by means of said LEDs 70 along the extension direction R extended stripe shaped areas 72 of the pane cover 90 can be illuminated homogeneously such that they are seen on said pane cover 90 by a driver. Hereunto, said pane cover 90 extends with its areas of low translucence or strong diffusion along the direction of assembly A above said reflector means 71 and the LEDs 70 housed therein. To have a better separation of the light stripes 72 on the pane cover with respect to each other, additional separation areas can be provided in or on the pane cover 90, that have a low translucence.

Said recess 33 of the upper first shell 31 is formed in a way, that also the LEDs 70 and the essentially homogeneously illuminated areas 72 (so-called light stripes) on the pane cover 90 can be seen through the recess 33 by a driver. Preferably, the reflector means 71 consist of PC, ABS oder coated plastic material. The pane cover 90 can have several layers in the area of the reflector means 71, particularly a coated aperture 90a as well as a diffuse foil 90b or a coating of the aperture, which is arranged between the reflector means 71 and the coated aperture 90a along the direction of assembly.

The display 32 and both reflector means 71 as well as the LEDs 70 housed therein, along with a central control unit 100 are attached onto a circuit board 35, which serves as a support of said components and further provides an electronic connection between the components such as the display 32 and the control unit 100.

For protection of the circuit board 35 a lower cover 92 is provided, that extends along the extension direction R and is arranged between the circuit board 35 and the base body 21 along the direction of assembly A. Preferentially, this lower cover 92 consists of PC or ABS.

For providing electronic connections between the display device 30, in particular the control unit 100, and a grid on the vehicle side, but also for transmission of control signals, a connection element 51 and an electrical connection unit 50 connected thereto is provided, wherein said connection unit 50 comprises an electrical cable 53, that is adapted and designed for being arranged in a cladding 22 of the base body 21. The electrical cable 53 can be integrated into the cladding during the production of the steering wheel 2. The electrical cable 53 can comprise several wires. Alternatively, the cable 53 can also be arranged in a groove of the base body 21 during production of the steering wheel 2.

For attaching the display device 30 to a base body 21 of a steering wheel rim 20 a lower shell 34 is provided, having an outer surface 34b hat faces away from the driver, wherein said lower shell 34 is preferably arranged at a side 21b of the base body 21 that faces away from the driver and the display 32, respectively. The lower shell 34 can particularly be covered by an outer, visible cladding 25 of the steering wheel rim 20—also denoted as further cladding 25—that preferentially consists of a leather. Preferably, the lower shell 34 consists of PC or ABS.

FIG. 4 shows in conjunction with FIGS. 5 and 9 the attachment of the display device 30 to a steering wheel rim 20 of a steering wheel 2, which rim 20 circulates along an extension direction R (circumferential direction). The steering wheel rim 20 thereby comprises a base body 21 circulating along the extension direction R as a skeletal structure of the steering wheel rim 20. Preferably, the base body 21 consists of a metal, but can also be produced from a plastic material.

Further, the steering wheel rim 20 comprises a cladding 22 out of a material that preferentially has a higher elasticity than the base body 21, wherein said cladding 22 surrounds the base body 21 along the extension direction R at least in sections, i.e., it encompasses the profile of the base body 21, and is also referred to as base body cladding 22. Finally, the steering wheel rim 20 comprises a further cladding 25 having an outer visible surface, wherein this further cladding 25 is attached to the base body cladding 22 and surrounds the base body cladding 22 along the extension direction R at least in sections. This further cladding 25 preferentially consists of a leather (sleeve 25).

For attaching the display device 30 to the steering wheel 2, the base body cladding 22 comprises a gap along the extension direction R, that is located—with respect to a straight ahead driving position of the steering wheel rim 20—in the twelve o'clock position, so that a portion 93 of the base body 21 is not covered by said base body cladding 22. From this portion 93 two attachment structures in the form of two attachment areas 41 protrude like processes across the extension direction R, namely towards a hub body 94 of the steering wheel 2, which is connected to the steering wheel rim 20 via at least one spoke 95 of the steering wheel 2. The two attachment areas 41 are spaced apart along the extension direction R and comprise a through opening 42, respectively (for instance in form of a borehole), that extends normal to the steering shaft 150 of the steering wheel 2.

Through each of said through openings 42 an attachment means, for instance in form of a screw 44, is inserted, so as to connect the lower shell 34 and the upper first shell of the display device 30. Hereunto two corresponding threads are preferably provided at the upper first shell 31, the screw heads rest against a side 34b of the lower shell 34 that faces away from the base body 21. Thus, both of said shells 31, 34 can be pressed against each other by means oft he screws 44. Since both screws 44 reach through the through openings 42 provided at the base body 21, the display device 30 is attached to the base body 21 such that it cannot be rotated around the base body 21. Furthermore, by means of said attachment means 41, 42, 44 the circuit board 35 can of course also be fixed between both shells 31, 34, and the seal 91 can be pretensioned between the pane cover 90 and the display 32 along the direction of assembly A.

Alternatively or additionally, the display device 30 can be attached to the base body 21 be means of removable glueing means, that can be for instance removed by applying ultrasonic or heat. In the case of glueing means that can be removed by applying heat, a heating wire can be arranged near or in the glued connection. Such removable connections allow for accessing the components of the display device 30 for service purposes.

To suppress turnings and vibrations of the circuit board 35 with respect to the base body 21, the circuit board 35 can be connected to the base body 21 via a latching means 43. Hereunto an engagement hook 45 of said latching means 43 preferably protrudes along the direction of assembly A from the circuit board 35 towards the base body 21 and engages a recess provided at the base body 21 with a free end portion 45a of the engagement hook 45, so that the circuit board 35 is at least arrested with respect to the base body 21 along the direction of assembly A.

Furthermore, according to FIG. 8, the display 32 is preferably connected elastically to the circuit board 35, because of its stiffness compared the softer circuit board 35 and the corresponding different eigen modes (resonant frequencies). Preferentially, it is connected via damping means 36 to the circuit board 35, which are arranged between the display 32 and the circuit board 35 with respect to the direction of assembly A. Said damping means 36 can consist of a glue which—in a hardened state—has elastic properties. The frame shaped seal 91 also contributes to the decoupling of the display 32 from neighboring components of the display device 30.

In the preceding description, the following abbreviations have been used: ABS (acrylonitrile-butadiene-styrene), OLED (organic light emitting diode), PC (polycarbonate), PMMA (polymethyl methacrylate), PU (polyurethane), and TFT (thin film transistor).

1.-38. (canceled)

39. A steering wheel assembly for a motor vehicle having
a steering wheel for steering the motor vehicle,
at least one vehicle component that is arranged at the steering wheel, and
an electronic control unit for processing information and for controlling the at least one vehicle component,
wherein the electronic control unit is arranged in the steering wheel.

40. The steering wheel assembly according to claim 39, wherein the at least one vehicle component is arranged at a steering wheel rim by means of which the steering wheel can be actuated.

41. The steering wheel assembly according to claim 39, wherein the at least one vehicle component is arranged at a steering wheel hub body by means of which the steering wheel is connected to a steering shaft.

42. The steering wheel assembly according to claim 39, wherein the at least one vehicle component is designed as an actuator for a superposition steering system.

43. The steering wheel assembly according to claim 39, further comprising a superposition steering system for a motor vehicle that is designed for correcting a steering angle adjusted by the driver via the steering wheel and/or to provide synthetic feedback to the driver, wherein the steering wheel assembly is particularly designed for being decoupled or for becoming decoupled from the steered wheels of the motor vehicle.

44. The steering wheel assembly according to claim 39, wherein the at least one vehicle component is designed as a display device.

45. The steering wheel assembly according to claim 39, wherein the control unit is designed for controlling further vehicle components, particularly at least one of: a heating element, a lighting means, and actuating means for actuating a vehicle component.

46. The steering wheel assembly according to claim 39, wherein the control unit is adapted and provided for being connected to a bus on the motor vehicle side via a bus transceiver.

47. The steering wheel assembly according to claim 39, further comprising a memory means that is to be arranged in the motor vehicle, particularly for storing image information that is to be displayed by the display device and/or for storing information that is needed for the generation of control signals for said superposition steering system.

48. The steering wheel assembly according to claim 39, wherein the control unit is arranged in one of: a steering wheel rim, a hub body of the steering wheel, and a spoke connecting the steering wheel rim with the hub body.

49. The steering wheel assembly according to claim 39, wherein the control unit comprises a circuit board for supporting components of the control unit.

50. The steering wheel assembly according to claim 39, wherein a part of the steering wheel at which the control unit or at least one of the vehicle components that is controlled by the control unit is arranged, is designed as a heat sink.

51. The steering wheel assembly according to claim 39, wherein the control unit is designed for conducting signal processing that is necessary for controlling the display device and/or the actuator.

52. The steering wheel assembly according to claim 39, wherein the control unit is designed for processing vehicle information from a bus present in the motor vehicle.

53. The steering wheel assembly according to claim 39, wherein vehicle information processed by the control unit is provided by vehicle sensors which are arranged in the steering wheel or outside the steering wheel.

54. The steering wheel assembly according to claim 39, wherein the control unit is designed for processing driver information that is recorded by a driver monitoring device, particularly in form of a camera, wherein said driver monitoring device is arranged at the steering wheel and connected to the control unit.

55. The steering wheel assembly according to claim 39, wherein the control unit is designed for reading vehicle information from a bus on the motor vehicle side in an autonomous manner, particularly without preparation of the motor vehicle bus system with respect to the additional bus member or a change in the bus architecture.

56. The steering wheel assembly according to claim 39, wherein the control unit is designed for processing diagnose and/or data safety monitoring information in a autonomous manner, and in that the control unit is designed for transmitting signals to the display device for displaying such information.
